(19) United States
(12) Patent Application Publication
(10) Pub. No.: US 2006/0221118 A1
(43) Pub. Date: Oct. 5, 2006

(54) Inkjet head and inkjet printer with the same

(75) Inventors: Gu-hwan Na, Seoul (KR); Jin-ho Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/280,455

(22) Filed: Nov. 17, 2005

(30) Foreign Application Priority Data
Apr. 4, 2005 (KR) 10-2005-0028074

(51) Int. Cl. B41J 2/165

(52) U.S. Cl. 347/22

(57) ABSTRACT

An inkjet head for discharging ink to print an image and an inkjet printer with the same are provided. The inkjet head includes an ink cartridge filled with ink. The inkjet head has a nozzle portion with a nozzle for discharging ink. A cap bracket is connected to the ink cartridge and pivotally moves between a first position which covers the nozzle portion and a second position which opens the nozzle portion. A cleaning member is provided to the cap bracket and contacts the nozzle portion to clean the nozzle portion during movement of the cap bracket.

### CROSS-REFERENCE TO RELATED PATENT APPLICATION

This application claims the benefit under 35 U.S.C. § 119(a) of Korean Patent Application No. 10-2005-0028074, filed on Apr. 4, 2005, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an inkjet head having a cleaning member for cleaning a nozzle, and an inkjet printer with the same.

2. Description of the Related Art

In general, an inkjet printer includes an inkjet head spaced apart from a recording sheet at a predetermined interval. The inkjet head discharges ink onto the recording sheet to form an image.

One example of such an inkjet printer is disclosed in U.S. Pat. No. 6,637,856, which issued to Nishi et al. on Feb. 14, 2002 and is entitled “Inkjet Head and Inkjet Printer.” This patent, which is incorporated by reference in its entirety, discloses an inkj et printer with an inkjet head that includes a head cap for protecting an ink discharge surface of a print head.

Typically, such an inkjet printer includes a cleaning means to clean the inkjet head. FIGS. 1 through 3 depict the sequential operation of one such cleaning means provided to the inkjet printer.

Referring to FIGS. 1 through 3, a conventional inkjet printer includes an ink cartridge 3 filled with ink, and a head cap 5 for protecting a lower end of the ink cartridge 3. A nozzle (not shown) is formed on the lower end of the ink cartridge 3. A cleaning roller 7 is installed inside the head cap 5 to clean the nozzle of the ink cartridge 3.

If a print command is input to the inkjet printer, the head cap 5 is moved from the position shown in FIG. 1 (that is, under the ink cartridge 3) to the position shown in FIG. 3 by moving it along the route indicated by the double dotted line. The head cap is moved by a moving means, and passes through the intermediate position shown in FIG. 2. The nozzle of the ink cartridge is cleaned by the moving cleaning roller 7. When the head cap 5 reaches the position shown in FIG. 3 and the nozzle of the ink cartridge 3 is open, the recording sheet P is conveyed under the ink cartridge 3, and ink is discharged onto the recording sheet P to print an image on the recording sheet P.

Since the construction of the moving means for moving the head cap 5 is complicated, manufacturing cost is increased, and operational reliability is diminished. In addition, the head cap 5 is not connected to the ink cartridge 3. Hence, when the ink cartridge 3 is detached from the inkjet printer for storage, an additional cap is required to close the nozzle of the ink cartridge 3.

Accordingly, there is a need for an improved cleaning means for an inkjet head, and an inkjet printer that uses the same.

### SUMMARY OF THE INVENTION

An aspect of the present invention is to address at least the above problems and/or disadvantages and to provide at least the advantages described below. Accordingly, an aspect of the present invention is to provide an inkjet head that is capable of being attached or detached from an inkjet printer, with cleaning means being attached to an ink cartridge, and an inkjet printer with the inkjet head.

According to an aspect of the present invention, an inkjet head for an inkjet printer comprises an ink cartridge filled with ink. The inkjet cartridge has a nozzle portion with a nozzle for discharging ink. A cap bracket is connected to the ink cartridge and pivotally moves between a first position which covers the nozzle portion and a second position which opens the nozzle portion. A cleaning member is provided to the cap bracket and contacts the nozzle portion to clean the nozzle portion during movement of the cap bracket.

The cleaning member may be a rubber piece protruding from the cap bracket towards the ink cartridge.

The cleaning member may be a foamed resin capable of absorbing ink.

The inkjet head may include a capping member in the cap bracket, which contacts the nozzle portion by the locking portion and the capping member guide when the cap bracket is positioned in the first position.

The cap bracket may include a capping member guide for guiding the capping member away from the nozzle portion when the cap bracket moves from the first position to the second position and guiding the capping member against the nozzle portion when the cap bracket moves from the second position to the first position.

The capping member may have a locking portion that protrudes towards the ink cartridge. The locking portion contacts the nozzle portion and prevents the capping member from moving along the capping member guide when the cap bracket is positioned in the first position.

The capping member may have a locking portion that protrudes towards the ink cartridge and contacts the nozzle portion to and the capping member guide when the cap bracket is positioned in the first position.

The cap bracket may include a transmission gear for transmitting power to the cap bracket so that the cap bracket is relatively rotated to the ink cartridge.

According to another aspect of the present invention, an inkj et printer includes means for transferring a recording sheet along a given transfer path and an inkjet head for printing an image onto the recording sheet transferred by the transferring means by discharging ink onto the recording sheet. The inkjet head comprises an ink cartridge filled with ink, and has a nozzle portion with a nozzle for discharging ink. A cap bracket is connected to the ink cartridge and pivotally moves between a first position which covers the nozzle portion and a second position which opens the nozzle portion. A cleaning member is provided to the cap bracket and contacts the nozzle portion to clean the nozzle portion during movement of the cap bracket.

The cleaning member may be a rubber piece protruding from the cap bracket towards the ink cartridge.

The cleaning member may be a foamed resin capable of absorbing ink.

The inkjet head may further comprise a capping member in the cap bracket, which contacts the nozzle portion when the cap bracket is positioned in the first position.

The capping member may have a locking portion that protrudes towards the ink cartridge. The locking portion contacts the nozzle portion and prevents the capping member from moving along the capping member guide when the cap bracket is positioned in the first position.

The capping member may have a locking portion that protrudes towards the ink cartridge. The locking portion contacts the nozzle portion and prevents the capping member from moving along the capping member guide when the cap bracket is positioned in the first position.

The inkjet printer may further comprise a motor for supplying rotating power, and the cam bracket may include a transmission gear receiving power from the motor.

The inkjet printer may further comprise a paper guide plate which is moved down when the cam bracket is positioned in the first position and is moved up when the cap bracket is positioned in the second position.

The paper guide plate may be resiliently biased upwardly, so that the paper guide plate is moved down by the cap bracket when the cam bracket is positioned in the first position, and is moved up by resilient force when the cap bracket is positioned in the second position.

### BRIEF DESCRIPTION OF THE DRAWINGS

The above and other objects, features, and advantages of certain embodiments of the present invention will be more apparent from the following description taken in conjunction with the accompanying drawings, in which:

FIGS. 1 through 3 are views of an example of a conventional inkjet printer, showing the operation of a cleaning means installed in the inkjet printer;

FIG. 4 is a schematic view of an inkjet printer according to an exemplary embodiment of the present invention;

FIG. 5 is an exploded perspective view of the inkjet head in FIG. 4; and

FIGS. 6 through 10 are views showing the operation of the cleaning means installed in the inkjet head in FIG. 4.

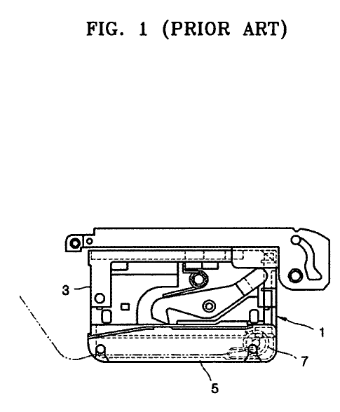

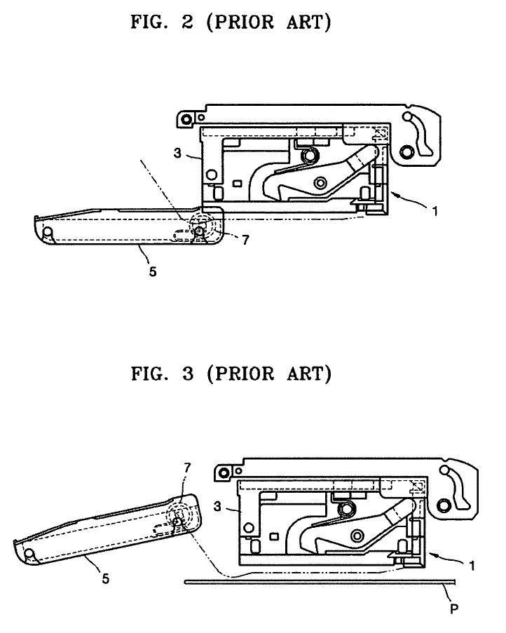

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

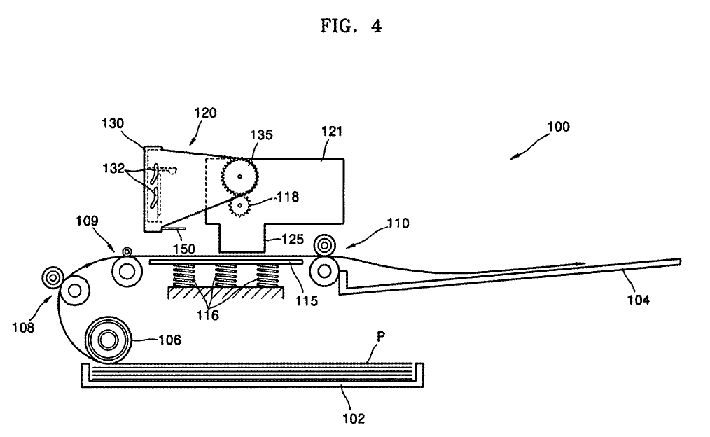

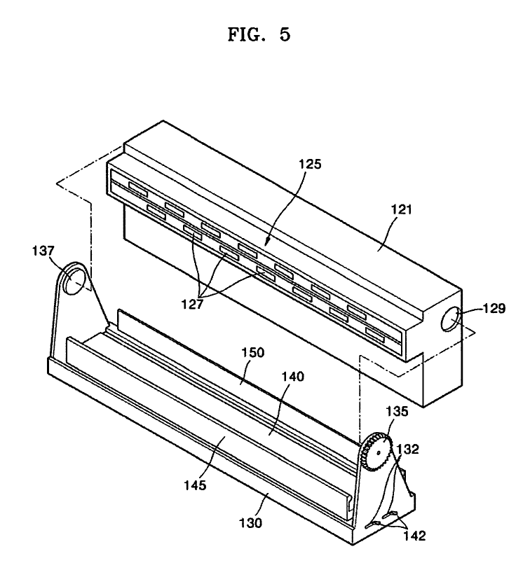

FIG. 4 is a schematic view of an inkjet printer 100 according to an exemplary embodiment of the present invention, and FIG. 5 is an exploded perspective view of the inkjet head in FIG. 4.

Referring to FIGS. 4 and 5, the inkjet printer 100 includes a paper feeding tray 102 for stacking a recording sheet P to be printed thereon, a delivery tray 104 for stacking the printed recording sheet P thereon, transfer means for transferring the recording medium P one by one along a transfer path from the paper feeding tray 102 to the delivery tray 104, and an inkjet head 120 for discharging ink onto the recording paper P transferred along the transfer path to print an image.

The transfer means has a pickup roller 106 for picking up the recording sheet P from the paper feeding tray 102 one by one, a first paper feeding roller 108 and a second paper feeding roller 109 for aligning the picked up recording sheet P and feeding it under an ink cartridge 121, and a delivery roller 110 for delivering the recording sheet P with the image formed by ink discharge.

The inkjet cartridge 121 which is filled with ink is on the inkjet head 120, and a cap bracket 130 is rotatably connected to the ink cartridge 121. The ink cartridge 121 has a nozzle portion 125 with a plurality of nozzles 127 which are formed at a lower end surface of the nozzle portion to discharge ink. The nozzles 127 protrude downward from the lower end surface of the nozzle portion 125. In the illustrated embodiment, the nozzle portion 125 is substantially the same width as the recording sheet P to print data on the recording sheet P. That is, according to an exemplary embodiment, the nozzle portion is a line unit.

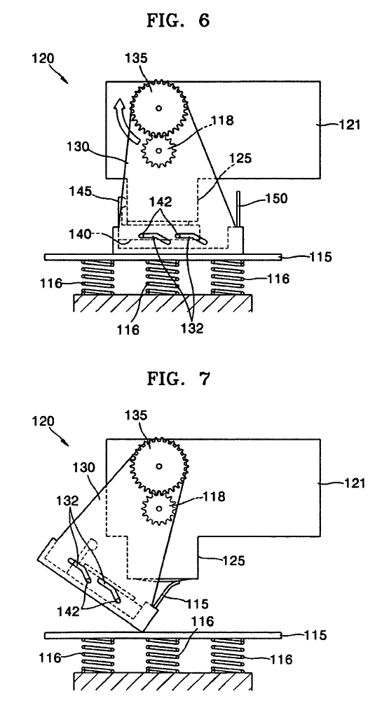

The ink cartridge 121 is formed with a pair of circular coupling recesses 129 at both ends thereof. The cap bracket 130 is provided with a pair of coupling bosses 137 which are mounted to the coupling recesses 129. As such, the cap bracket 130 may be rotatably connected to the ink cartridge 121. The cap bracket 130 is pivotally moved between a first position that blocks the transfer path of the recording sheet P and covers the nozzle 125 of the ink cartridge 121 (see FIG. 6) and a second position where it is moved out of the transfer path of the recording sheet P and opens the nozzle portion 125 to discharge ink (see FIG. 4). The bracket 130 has a transmission gear 135 which is aligned with a line connecting the coupling bosses 137. The transmission gear 135 is meshed with a drive gear 118 meshed with a shaft of a motor (not shown) as a drive source. Hence, if the shaft is rotated, the cap bracket 130 is pivotally moved from the first position to the second position, and vice versa, depending upon the rotating direction.

A paper guide plate 115 is disposed under the inkjet head 120 to guide the recording sheet P moving under the ink cartridge 121 and thereby to form the transfer path. The paper guide plate 115 is resiliently biased upward by means of a spring 116. When the cap bracket 130 is positioned in the first position, the paper guide plate 115 is pushed by the cap bracket 130, and is thus moved down. When the cap bracket 130 is positioned in the second position, the paper guide plate 115 is moved up by the resilient force of the spring 116 to form the transfer path of the recording sheet P.

If the printing command is input to the inkjet printer 100, the cap bracket 130 of the inkjet head 120 is pivotally moved to the second position, as shown in FIG. 4, so that the nozzle portion 125 of the ink cartridge 121 is opened. And, the paper guide plate 115 is moved up by the resilient force of the spring 116 to form the transfer path of the recording sheet P. The uppermost sheet of the recording sheets P stacked on the paper feeding tray 102 is sequentially picked up by the pickup roller 106. The uppermost sheet is transferred to the first paper feeding roller 108 and the second feeding roller 109, and is then passed under the ink cartridge 21. At that time, ink is discharged from the nozzles 127 formed at the lower end surface of the nozzle portion 125, thereby printing the image on the recording sheet P. The recording sheet P with the image formed thereon by the ink discharge is delivered by a delivery roller 110 so that the recording sheet is stacked on the delivery tray 104.

Referring again to FIG. 5, the cap bracket 130 has a capping member 140 which contacts the nozzle portion 125 to prevent leakage of ink through the nozzle 127 when the cap bracket 130 is positioned in the first position, and a cleaning member 150 for cleaning the nozzle 127 of the nozzle portion 125 and the periphery of the nozzle.

The cap bracket 130 is formed with slot-shaped capping member guides 132 at both sides thereof. Guide bosses 142 formed at both ends of the capping member 140 are inserted into the capping member guides 132. As such, the capping member 140 is slidably attached to the cap bracket 130. The capping member 140 has a locking portion 145 protruding towards the ink cartridge 121. The locking portion 145 contacts the nozzle portion 125 and prevents the capping member 140 from moving along the capping member guides 132 when the cap bracket is positioned in the first position.

The cleaning member 150 contacts the lower end of the nozzle portion 125 to wipe residual ink or foreign substances from around the nozzle 127 when the cap bracket 130 is pivotally moved from the first position to the second position or from the second position to the first position. In the illustrated embodiment, the cleaning member 150 shown in FIG. 5 is a rubber piece attached to the cap bracket 130 and protruding towards the ink cartridge 121. Alternatively, the cleaning member may be formed of a sponge or foamed resin capable of absorbing ink or foreign substances.

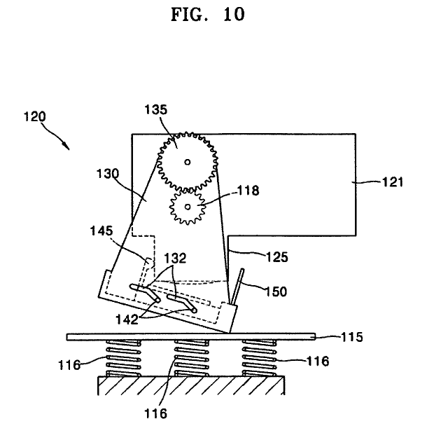

FIGS. 6 and 10 are views sequentially showing the operation of the cleaning means installed to the inkjet head in FIG. 4.

FIG. 6 shows a printing standby state in which the print command is not input to the inkjet printer 100 (FIG. 4). At that time, the cap bracket 130 is positioned in the first position, and the capping member 140 contacts the lower end surface of the nozzle portion 125 of the ink cartridge 121, thereby preventing ink from leaking through the nozzle 127 (FIG. 5). The locking portion 145 of the capping member 140 contacts the nozzle portion 125, and the guide bosses 142 of the capping member 140 contact a left border of the capping member guide 132, so that the capping member 140 is adjacent to the lower end surface of the nozzle portion 125. The paper guide plate 115 is resiliently biased against the bottom surface of the cap bracket 130 by the spring 116.

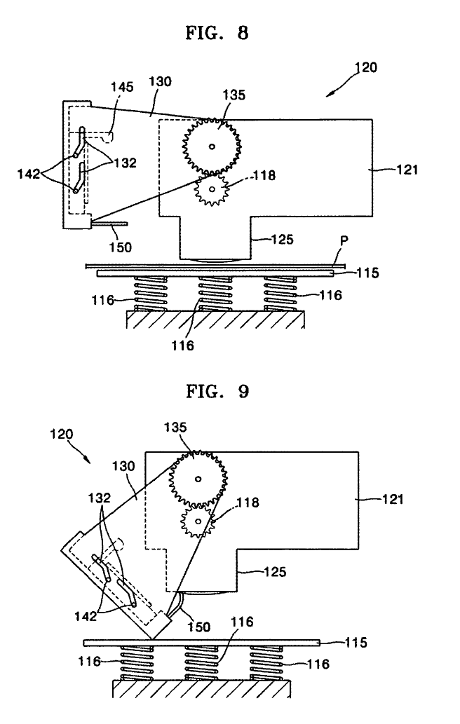

If the print command is input to the inkjet printer 100, the drive gear 118 is rotated by the motor (not shown), and the transmission gear 135 is thus rotated in a clockwise direction. Hence, the cap bracket 130 is pivoted from the 6 o' clock position (FIG. 6), through the 8 o' clock position (FIG. 7), to the 9 o' clock position (FIG. 8). While the cap bracket 130 is pivoting, the cleaning member 150 wipes the lower end surface of the nozzle portion 125, as shown in FIG. 7.

Referring to FIG. 8, when the cap bracket 130 is positioned in the 9 o' clock position, the guide boss 142 of the capping member 140 contacts a right border of the capping member guide 132 because the capping member 140 slides against the cap bracket 130 by its weight. The paper guide plate 115 is moved up to a position adjacent to the nozzle portion 125 by the spring 116 to form the transfer path of the recording sheet P. The recording sheet P is transferred between the nozzle portion 125 and the paper guide plate 115, so that the image is printed by ink discharge.

When printing is completed, the drive gear 118 is rotated in a clockwise direction by the motor, and the transmission gear 135 is rotated in the counterclockwise direction by the driving force. Hence, the cap bracket 130 is returned to the print standby state (FIG. 6) from the 9 o' clock position (FIG. 8), passing through the 8 o' clock position (FIG. 9) and the 7 o' clock position (FIG. 10). While the cap bracket 130 is pivotally moved in the counterclockwise direction, the cleaning member 150 wipes the lower end surface of the nozzle portion 125 to again clean it, as shown in FIG. 9.

Referring to FIG. 10, the locking portion 145 of the capping member 140 contacts the nozzle portion 125, so that the capping member 140 is not further pivotally moved along the cap bracket 130. Only the cap bracket 130 is further pivotally moved to the 6 o' clock position, so that the guide boss 142 of the capping member 140 is slid against the capping member guide 132. Hence, the guide boss 142 again contacts the left border of the capping member guide 132, as shown in FIG. 6,, and the capping member 140 again contacts the lower end surface of the nozzle portion 125 to prevent leakage of ink. Meanwhile, the paper guide plate 115 is pushed by the cap bracket 130, and is thus moved down.

The inkjet printer with the inkjet head of the present invention includes one module composed of the ink cartridge filled with ink, the cap bracket for preventing leakage of ink, and the cleaning member for cleaning the nozzle portion of the ink cartridge, thereby easily replacing the inkjet head. Also, when the ink cartridge is removed from the inkjet printer and stored, additional caps are not necessary to prevent ink leakage.

Also, the mechanism of cleaning the nozzle portion of the ink cartridge is simpler relative to a conventional inkjet printer, thereby improving the reliability of operation and reducing manufacturing cost.

While the invention has been shown and described with reference to certain embodiments thereof, it will be understood by those skilled in the art that various changes in form and details may be made therein without departing from the spirit and scope of the invention as defined by the appended claims.

What is claimed is:

1. An inkjet head for an inkjet printer comprising:
an ink cartridge comprising a nozzle portion with a nozzle for discharging ink;
a cap bracket connected to the ink cartridge and pivotally movable between a first position which covers the nozzle portion and a second position which opens the nozzle portion; and
a cleaning member arranged with respect to the cap bracket and contacting the nozzle portion to clean the nozzle portion during movement of the cap bracket.

2. The inkjet head according to claim 1, wherein
the cleaning member comprises a rubber piece protruding from the cap bracket towards the ink cartridge.

3. The inkjet head according to claim 1, wherein
the cleaning member comprises a foamed resin capable of absorbing ink.

4. The inkjet head according to claim 1, further comprising
a capping member arranged with respect to the cap bracket and contacting the nozzle portion when the cap bracket is positioned in the first position.

5. The inkjet head according to claim 4, wherein
the cap bracket comprises a capping member guide for guiding the capping member away from the nozzle portion when the cap bracket moves from the first position to the second position and for guiding the capping member against the nozzle portion when the cap bracket moves from the second position to the first position.

6. The inkjet head according to claim 5, wherein
the capping member comprises a locking portion protruding towards the ink cartridge, and the locking portion contacts the nozzle portion and prevents the capping member from moving along the capping member guides when the cap bracket is positioned in the first position.

7. The inkjet head according to claim 1, wherein
the cap bracket comprises a transmission gear for transmitting power to the cap bracket so that the cap bracket is relatively rotated to the ink cartridge.

8. An inkjet printer which transfers a recording sheet along a given transfer path and comprises an inkjet head for printing an image onto the recording sheet by discharging ink onto the recording sheet, the inkjet head comprising:
an ink cartridge comprising a nozzle portion with a nozzle for discharging ink;
a cap bracket connected to the ink cartridge and pivotally movable between a first position which covers the nozzle portion and a second position which opens the nozzle portion; and
a cleaning member arranged with respect to the cap bracket and contacting the nozzle portion to clean the nozzle portion during movement of the cap bracket.

9. The inkjet printer according to claim 8, wherein
the cleaning member comprises a rubber piece protruding from the cap bracket towards the ink cartridge.

10. The inkjet printer according to claim 8, wherein
the cleaning member comprises a foamed resin capable of absorbing ink.

11. The inkjet printer according to claim 8, further comprising
a capping member arranged with respect to the cap bracket and contacting the nozzle portion when the cap bracket is positioned in the first position.

12. The inkjet printer according to claim 11, wherein
the cap bracket comprises a capping member guide for guiding the capping member away from the nozzle portion when the cap bracket moves from the first position to the second position and for guiding the capping member against the nozzle portion when the cap bracket moves from the second position to the first position.

13. The inkjet printer according to claim 12, wherein
the capping member comprises a locking portion protruding towards the ink cartridge, and the locking portion contacts the nozzle portion and prevents the capping member from moving along the capping member guides when the cap bracket is positioned in the first position.

14. The inkjet printer according to claim 8, further comprising:
a motor for supplying rotating power; and
a transmission gear located on the cap bracket to receive power from the motor.

15. The inkjet printer according to claim 8, further comprising
a paper guide plate which is moved down when the cap bracket is positioned in the first position and is moved up when the cap bracket is positioned in the second position.

16. The inkjet printer according to claim 15, wherein
the paper guide plate is resiliently biased upwardly, so that the paper guide plate is moved down by the cap bracket when the cam bracket is positioned in the first position, and is moved up by resilient force when the cap bracket is positioned in the second position.
